(19) United States
(12) Patent Application Publication
(10) Pub. No.: US 2023/0192120 A1
(43) Pub. Date: Jun. 22, 2023

(54) INCREASING SIMULATION DIVERSITY FOR AUTONOMOUS VEHICLES

(71) Applicant: GM CRUISE HOLDINGS LLC, San Francisco, CA (US)

(72) Inventors: Ignacio Martin-Bragado, Mountain View, CA (US); Leftheris Kaleas, San Francisco, CA (US); Eugene Wong, Berkeley, CA (US)

(21) Appl. No.: 17/557,938

(22) Filed: Dec. 21, 2021

(51) Int. Cl. B60W 60/00; G06K 9/62; G06N 20/00; B60W 40/08

(52) U.S. Cl. CPC B60W 60/001; G06K 9/6256; G06N 20/00; B60W 40/08; B60W 2420/52; B60W 2420/42; B60W 2040/0881

(57) ABSTRACT

The present technology pertains to increasing diversity of simulated autonomous vehicle (AV) environment scenes to be used for training machine learning (ML) models. Such an increase in diversity may be achieved by selecting objects from simulated AV environemnt scenes, and determining whether to add attachments to attachment points of the objects based on probabilities associated with the attachment points. When an attachment is to be added to an attachment point, the particular attachment is selected from among a set of compatible attachments.

### TECHNICAL FIELD

The subject matter of this disclosure relates in general to the field of autonomous vehicles, and more particularly, to systems and methods for increasing simulation diversity for training autonomous vehicle machine learning models.

### BACKGROUND

An Autonomous Vehicle (AV) is a motorized vehicle that can navigate without a human driver. The AV can include a plurality of sensor systems, such as a camera system, a Light Detection and Ranging (LIDAR) system, a Radio Detection and Ranging (RADAR) system, and so on. The AV may operate based upon sensor signal output of the sensor systems. For example, the sensor signals can be provided to a local computing system in communication with the plurality of sensor systems, and a processor can execute instructions based upon the sensor signals to control one or more mechanical systems of the AV, such as a vehicle propulsion system, a braking system, a steering system, and so forth.

The AV may depend on geographic and spatial (geospatial) data to localize itself (e.g., obtain its position and orientation (pose)) and other objects within its immediate surroundings, determine routes towards destinations, and to coordinate motor controls to maneuver safely and efficiently while in transit, among other operations. The AV geospatial data can include the various dimensions or attributes (e.g., Global Positioning System (GPS) coordinates; polygon vertices; polyline vertices; length, width, height; radial distance, polar angle; etc.) of physical places and things (e.g., streets, lanes, crosswalks, sidewalks, medians, traffic signal poles, traffic signs, etc.). The AV geospatial data can also include abstract or semantic features (e.g., speed limits, carpool lanes, bike lanes, crosswalks, intersections, legal or illegal U-turns, traffic signal lights, etc.) that the AV can evaluate to determine the next set of actions it may take for a given situation. For example, an intersection tagged as a permissive left turn may indicate that it is legal for the AV to turn left on a solid green traffic signal light so long as the AV yields to any oncoming traffic (i.e., other objects). The annotation of locations, objects, and features can require at least some human intervention, such as the manual labeling of certain areas, physical things, or concepts; quality assurance review of computer-generated geospatial observations; computer-aided design of maps; and so on. In order to prepare an AV for navigating autonomously, a machine learning model may use information about one or more environments surrounding any number of AVs as input. Such input may allow the machine learning model to be trained to recognize, assess, and/or react to such environments.

### BRIEF DESCRIPTION OF THE DRAWINGS

FIG. 1 illustrates an example of a system for managing one or more Autonomous Vehicles (AVs) in accordance with some aspects of the present technology.

FIG. 2 illustrates an example lifecycle of a ML model in accordance with some aspects of the present technology.

FIG. 3 illustrates an example of a simulation platform in accordance with some aspects of the present technology.

FIG. 4 is a flowchart of a method for increasing simulation diversity for autonomous vehicle (AV) machine learning (ML) in accordance with some aspects of the present technology.

FIG. 5 shows an example of a modified simulated AV environment scene in accordance with some aspects of the present technology.

FIG. 6 shows an example of a computing system for implementing certain aspects of the present technology.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

The present technology can involve the gathering and using data available from various sources to improve quality and experience. The present disclosure contemplates that in some instances, this gathered data may include personal information. The present disclosure contemplates that the entities involved with such personal information respect and value privacy policies and practices.

In general, embodiments described herein relate to increasing the diversity of simulated AV environment scenes that are used to generate data for training machine learning (ML) models, which may, for example, be deployed on an AV. In one or more embodiments, a simulated AV environment scene is a computer implemented representation of an environment surrounding an AV. In one or more embodiments, a given simulated AV environment scene is based, at least in part, on real-world scenes derived from data obtained by the various sensors of an AV. A simulated AV environment scene may have any number of objects, which may be associated with metadata, provided by artists, labeling the objects. Any other technique for labeling objects (e.g., using a trained machine learning model, by human annotators, etc.) may be used without departing from the scope of embodiments described herein. A simulated AV environment scene may be further augmented to have bounding boxes associated with objects in the scene. Any number of simulated AV environment scenes may be used to generate input data for training ML models. However, basing such scenes on real-world scenes encountered by one or more AVs may limit the diversity of such simulated AV environment scenes, as each simulated scene would require that an actual AV encounter a particular environment and that the data related to that environment be obtained from the AV in order to generate the simulated AV environment scene.

Embodiments described herein may address the above and other deficiencies of using simulated AV environment scenes based on real-world scenarios encountered by AVs. Specifically, in one or more embodiments, the diversity of simulated AV environment scenes to be used for generating input to ML models during ML model training is increased using an attachment system. In one or more embodiments, an attachment system is a system for adding attachments to objects in a simulated AV environment scene to obtain any number of modified simulated AV environment scenes. The attachment system, for all or any portion of the labeled objects in a simulated AV environment scene (e.g., other vehicles, pedestrians, stationary objects, etc.), may add one or more attachments to the object at one or more attachment points, thereby modifying the simulated AV environment scene. As an example, an object in a simulated AV environment scene may be labeled as a pedestrian. The pedestrian may have an associated head attachment point, back attachment point, and two hand attachment points defined. Head attachments, such as hats, helmets, etc., may be added to the pedestrian at the head attachment point. Back attachments, such as backpacks, may be added to the pedestrian at the back attachment point. Similarly, anything a pedestrian may have in one or both hands may be added to the hand attachment points.

Each attachment point of each object in a simulated AV environment scene may be associated with a probability that determines whether the attachment system will add an attachment to the object at the attachment point. For example, a rider attachment point for a motorcycle object may be associated with a 95% probability that a rider will be attached, thereby causing the attachment system to attach a rider to the motorcycle in 95% of the modified simulated AV environment scenes.

In one or more embodiments, when the probability of whether to add an attachment at a given attachment point of an object dictates that one will be added to the object for a particular instance of a modified simulated AV environment scene, the attachment system may then select an attachment to add to the object at the attachment point from an attachment database. The attachment database may be a database of possible attachments for various attachment points of various objects. The possible attachments may vary depending on the type of object and the type of attachment point. For example, the set of possible head attachments for a pedestrian will differ from possible passenger attachments for a motorized car or from a set of possible back attachments for the same pedestrian. Each attachment point of each type of object may have a different set of possible attachments in the attachment database. Some types of attachments may be in more than one set. Attachments may be any item, including items that might otherwise be considered objects. For example, a pedestrian may have an attachment point that has a set of attachments, such as a bicycle, which could hypothetically have been an object in a simulated AV environment scene. When an attachment is to be added to an attachment point of an object, any scheme for selecting an attachment from among a set of attachments may be used. For example, the attachment may be randomly selected. Attachments may be selected, at least in part, based on conditions associated with the attachment. For example, helmets may be associated with a condition that they may only be attached at head attachment points (e.g., of pedestrians, motorcycle riders, etc.)

In one or more embodiments, any number of attachments may be added to any number of objects for a given modified simulated AV environment scene. Further, any number of modified simulated AV environment scenes may be generated, each differing from one another based, at least in part, on the probabilities controlling whether an attachment is to be added to an attachment point for the various objects in the scene, and the different randomly selected attachments that are actually added to the objects.

Using the attachment system to add (or not) attachments to objects in simulated AV environment scenes allows for an exponential increase in the diversity of simulated scenes that may be used to derive input data for training ML models without having to have actual data from AVs encountering such scenes. In one or more embodiments, the increase in diversity improves the results of training ML models for use by AVs.

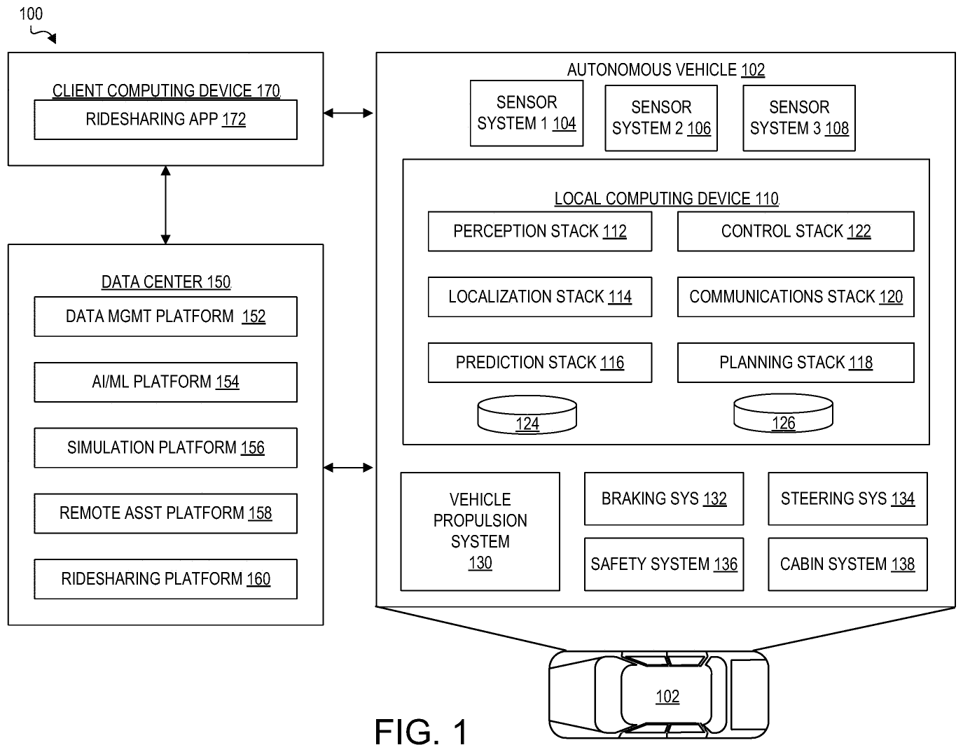

Turning now to the drawings, FIG. 1 illustrates an example of an autonomous vehicle (AV) management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and a high definition (HD) geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

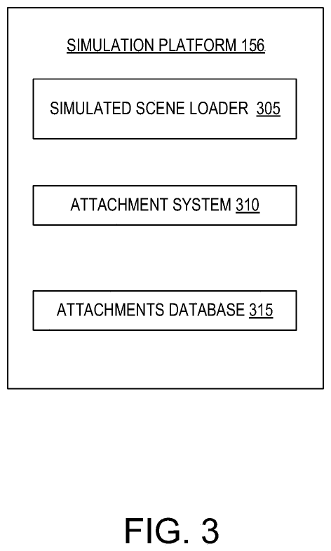

The simulation platform 156 can enable training, testing, and/or validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on. The simulation platform 156 can modify driving environments and/or real-world scenarios (i.e., simulated AV environment scenes) in order to increase the diversity of the scenes for use in training ML models to be used by an AV. As an example, training a machine learning model used that, when trained, is used, at least in part, for navigating an AV may be trained by providing inputs based on thousands of separate AV environment scenes during the training. It may be difficult to obtain that many simulated scenes based on real-world AV data. Therefore, in one or more embodiments, the simulation planform 156 may include an attachment system for attaching attachments to objects in simulated AV environment scenes, thereby increasing the diversity of the scenes by altering the objects therein. The simulation platform 156 and the attachment system are discussed further in the description of FIG. 3, below.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

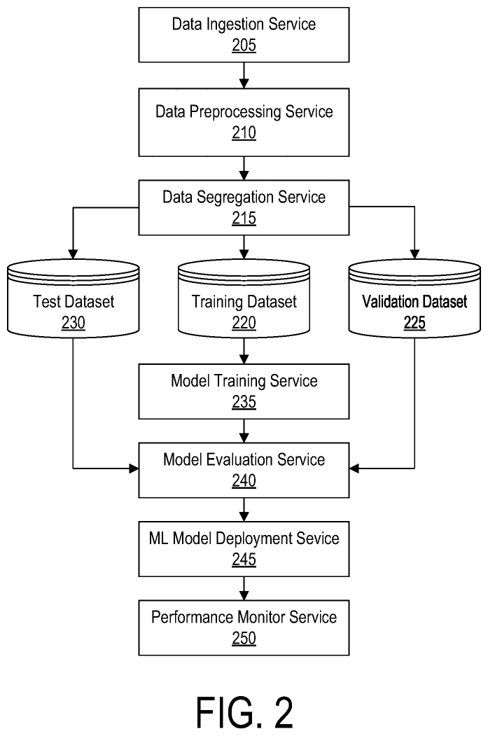

FIG. 2 illustrates an example lifecycle 200 of a ML model in accordance with some examples. The first stage of the lifecycle 200 of a ML model is a data ingestion service 205 to generate datasets described below. ML models require a significant amount of data for the various processes described in FIG. 2 and the data persisted without undertaking any transformation to have an immutable record of the original dataset. The data itself can be generated by sensors attached to an AV, for example, be provided from third party sources such as publicly available dedicated datasets used for research purposes, and/or be derived from simulated AV environment scenes, which may be based, at least in part, on real-world environments encountered by AVs. The data ingestion service 205 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data (e.g., an AV) from the consumer of the data (e.g., an ML model training pipeline). For offline data production, when source data is available from the producer (e.g., the AV), the producer publishes a message and the data ingestion service 205 retrieves the data. In some examples, the data ingestion service 205 may be online and the data is streamed from the producer (e.g., the AV) in real-time for storage in the data ingestion service 205.

After data ingestion service 205, a data preprocessing service 210 preprocesses the data to prepare the data for use in the lifecycle 200 and includes at least data cleaning, data transformation, and data selection operations. The data preprocessing service 210 removes irrelevant data (data cleaning) and general preprocessing to transform the data into a usable form. In some examples, the data preprocessing service 210 may convert three-dimensional (3D) LIDAR data (e.g., 2D point cloud data) into voxels. The data preprocessing service 210 includes labelling of features relevant to the ML model such as people, vegetation, vehicles, and structural objects in the case of an AV. In some examples, the data preprocessing service 210 may be a semi-supervised process performed by a ML to clean and annotate data that is complemented with manual operations such as labeling of error scenarios, identification of untrained features, etc.

In one or more embodiments, when simulated AV environment scenes are to be used to derive input data for training an ML model, the data preprocessing service 210 may generate any number of variations of any number of simulated AV environment scenes. Such variations may be created, for example, by adding attachments to objects identified in the simulated AV environment scene. An object in such a simulated scene may be any item that could conceivably be encountered by or otherwise within an environment surrounding an AV. Examples include, but are not limited to, movable objects such as other motorized vehicles (e.g., cars, trucks, motorcycles, etc.), human-powered vehicles (e.g., bicycles), pedestrians, trains, etc. Objects may also be stationary objects, such as, for example, fences, signs, buildings, obstructions, poles, dumpsters, etc. An attachment for an object may be anything that can be attached to the object. Examples of attachments include, but are not limited to, drivers, riders, co-riders, passengers, helmets, hats, backpacks, briefcases, shopping bags, signs, etc.

The set of items that may be attached to an object may vary based on the type of object. As an example, when an object in a simulated AV environment scene is a car, attachments may include a driver, one or more passengers, items being pushed or pulled by the car (e.g., a trailer), luggage racks, etc. As another example, when an object in a simulated AV environment scene is a motorcycle, attachments may include a rider, aesthetic motorcycle components, etc. As another example, when an object is a pedestrian, attachments may include a head attachment (e.g., a hat or helmet), a back attachment (e.g., a backpack), and one or more hand attachments (e.g., a briefcase, an umbrella, etc.). In one or more embodiments, an attachment may be something that could otherwise be considered an object. As an example, a bicycle, which may be considered as an object, may be instead an attachment for attaching to a pedestrian in a simulated AV environment scene. In one or more embodiments, attachments added to a simulated AV environment scene may also have further attachments. As an example, a motorcycle may be an object, and a rider may be added as an attachment. Further, a head attachment (e.g., helmet) and a back attachment (e.g., a backpack) may be added to the rider attachment that is attached to the motorcycle.

After the data preprocessing service 210, data segregation service 215 to separate data into at least a training dataset 220, a validation dataset 225, and a test dataset 230. Each of the training dataset 220, a validation dataset 225, and a test dataset 230 are distinct and do not include any common data to ensure that evaluation of the ML model is isolated from the training of the ML model.

The training dataset 220 is provided to a model training service 235 that uses a supervisor to perform the training, or the initial fitting of parameters (e.g., weights of connections between neurons in artificial neural networks) of the ML model. The model training service 235 trains the ML model based a gradient descent or stochastic gradient descent to fit the ML model based on an input vector (or scalar) and a corresponding output vector (or scalar).

After training, the ML model is evaluated at a model evaluation service 240 using data from the validation dataset 225 and different evaluators to tune the hyperparameters of the ML model. The predictive performance of the ML model is evaluated based on predictions on the validation dataset 225 and iteratively tunes the hyperparameters based on the different evaluators until a best fit for the ML model is identified. After the best fit is identified, the test dataset 230, or holdout data set, is used as a final check to perform an unbiased measurement on the performance of the final ML model by the model evaluation service 240. In some cases, the final dataset that is used for the final unbiased measurement can be referred to as the validation dataset and the dataset used for hyperparameter tuning can be referred to as the test dataset.

After the ML model has been evaluated by the model evaluation service 240, a ML model deployment service 245 can deploy the ML model into an application or a suitable device. The deployment can be into a further test environment such as a simulation environment, or into another controlled environment to further test the ML model. In the case of an AV, the ML model would need to undergo further evaluation inside a simulated environment and, after further validation, could be deployed in the AV. In some examples, the ML model could be implemented as part of the perception stack 112 to detect objects, or as part of the planning stack 118 for determining how to control an AV.

After deployment by the ML model deployment service 245, a performance monitor 250 monitors for performance of the ML model. In some cases, the performance monitor service 250 can also record performance data such as driving data that can be ingested via the data ingestion service 205 to provide further data, additional scenarios, and further enhance the training of ML models.

FIG. 3 illustrates an example of a simulation platform 156. One of ordinary skill in the art will understand that, for the simulation platform 156 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the simulation platform 156 includes a simulated scene loader 305, an attachment system 310, and an attachments database 315. Each of these components is described below.

In one or more embodiments, a simulated scene loader 305 is any hardware, software, or combination thereof, configured to request and receive simulated AV environment scenes (e.g., from data management platform 154 of FIG. 1). As an example, a perception stack of an AV may obtain data corresponding to a real-world environment encountered by an AV. The data may be provided to a service that converts the data into a simulation of the environment represented by the data, including all of the objects therein, which may be labeled (e.g., a particular type of car, a pedestrian, a fence, etc.) using any technique for labeling objects. The simulation of the environment may be referred to as a simulated AV environment scene, which may be received by the simulated scene loader 305. Additionally, the simulated scene loader 305 may include functionality to transmit modified simulated AV environment scenes after modification by attachment system 310. As an example, the modified simulated AV environment scenes may include simulated synthetic data, such as LIDAR cloud points, RADAR cloud points, images, etc. Such synthetic data may be provided to a ML model training system (not shown in FIG. 3) for use in training an ML model.

In one or more embodiments, an attachment system 310 is any hardware, software, or combination thereof, configured to modify simulated AV environment scenes by adding any number of attachments to any number of objects represented in the scene. In one or more embodiments, each object in a simulated AV environment scene may be associated with any number of attachment points. For example, a pedestrian object may have defined a head attachment point, a back attachment point, and two hand attachment points. In one or more embodiments, an attachment point is a location on an object where an attachment may be added to the object (e.g., adding a sombrero to a pedestrian at the head attachment point associated with the pedestrian). In one or more embodiments, the attachment system 310, for each such attachment point, may have a configured probability associated with the attachment point that defines the probability that, when generating a particular modified simulated AV environment scene, an attachment will be added to the object at the attachment point. For example, the back attachment point for a pedestrian object may have a 50% probability that a back attachment (e.g., a backpack) will be attached in a given instance of a modified simulated AV environment scene. In one or more embodiments, the attachment system 310 is configured to add, or not add, an attachment at an attachment point of an object based on the probability associated with the attachment point. The probabilities for various attachment points may be empirically determined.

In one or more embodiments, when the probability associated with a given attachment point dictates that an attachment will be added to the attachment point for a particular instance of a modified simulated AV environment scene, the attachment system 310 may select the attachment to add from an attachment database 315. In one or more embodiments, the attachment database 315 is a data structure (or collection of data structures) of any type for storing data representing attachments that may be added to objects by the attachment system 310. Each attachment point for each object type may have a different set of possible attachments stored in the attachment database 315, depending on the object type and attachment point. Thus, the attachment database, in some embodiments, may be organized, at least in part, with object types and attachment points serving as keys for accessing lists of attachments compatible with the attachment points and object types. Certain attachments for certain attachment points may be common to more than one object type, reducing the storage needed for data representing the attachments. For example, a driver attachment may be associated with a class of objects that includes cars and trucks. Thus, for all makes and models of cars or trucks in the class that may be used as a label for an object in a simulated AV environment scene, a common driver attachment may be stored in the attachment database 315.

The attachment system 310 may use any technique for selecting an attachment to add to an attachment point of an object when the probability associated with an attachment point of an object dictates that an attachment should be added to the object. For example, the attachment system 310 may use a random selection algorithm to randomly select an attachment from among the possible attachments for the attachment point of an object.

The attachment system 310 may be further configured to add attachments to other attachments at attachment points associated with the attachments, in a manner similar to the above-described techniques for adding an attachment to an attachment point of an object in a simulated AV environment scene. For example, an attachment system 310 may add a rider attachment to a motorcycle object based on an associated probability. The rider attachment may have defined head and back attachment points, each with an associated probability. When the probability dictates that an attachment should be added to the rider at one of the attachment points, the attachment system 310 may select an attachment to add to the attachment point of the rider attachment from the attachment database 315 (e.g., select a helmet to add to the head attachment point of the rider attachment). In one or more embodiments, the attachment system 310 may add further attachments to attachments in a recursive manner having any number of layers of recursion without departing from the scope of embodiments described herein.

The attachment system 310 may be further configured to add any other modifications to the simulated AV environment scene based on the adding of an attachment to an attachment point of either an object or another attachment. One example of such a modification includes modifying the bounding box associated with an object (or other attachment). For example, adding a large backpack to the back attachment point of a pedestrian object may significantly alter the shape of the pedestrian object. In such a scenario, the attachment system 310 may re-draw the bounding box associated with the pedestrian object to include the backpack attachment. Another example of such a modification is to add an associated animation to a particular combination of object (or other attachment) and attachment. As an example, a pedestrian may be an object, and a determination may be made to add a bicycle attachment to the pedestrian (or vice-versa). When the bicycle is added to the pedestrian object at a particular attachment point of the pedestrian, that may indicate that the pedestrian is walking the bicycle, which may have an associated pedestrian-walking-bicycle animation that is added as part of the modified simulated AV environment scene generated by the attachment system. However, when a pedestrian attachment is added to a bicycle object, a different associated animation may be added of the pedestrian riding the object.

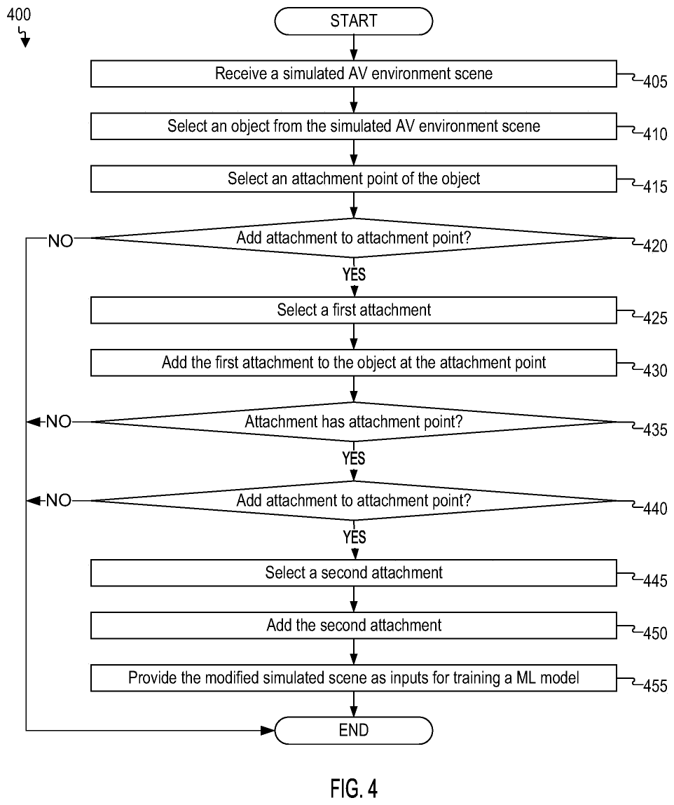

FIG. 4 illustrates an example method 400 for increasing simulation diversity for machine learning model training for AVs. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, the method includes receiving a simulated AV environment scene, the simulated scene including a plurality of objects at step 405. For example, the attachment system 310 illustrated in FIG. 3 may receive a simulated AV environment scene, the simulated scene comprising a plurality of objects. The simulated AV environment scene may be based, at least in part, on real-world data received by a perception stack of an AV. The objects in the simulated AV scene may be objects of any type. Examples of such objects include, but are not limited to, movable objects (e.g., cars, trucks, pedestrians, motorcycles, bicycles, trains, etc.) and stationary objects (e.g., buildings, fences, signs, poles, obstructions, etc.). In one or more embodiments, all or any portion of the objects in the simulated AV environment scene have an assigned label. Such a label may have been added to the simulated AV environment scene. In one or more embodiments, the labels assigned to the various objects in the simulated AV environment scene may have any level of detail and/or specificity. For example, a motorized vehicle may be labeled generally (e.g., car, truck, etc.) or more specifically (e.g., a car of a specific make and model).

All or any portion of the objects in the simulated AV environment scene may have associated attachment points corresponding to locations on the object. In one or more embodiments, an attachment point is a location on an object (or an attachment) at which an attachment may be attached. As an example, when an object is a pedestrian, the plurality of attachment points may include a head attachment point, a back attachment point, and hand attachment points. As another example, when an object is a vehicle, the plurality of attachment points may include vehicle occupant attachment points, aesthetic decoration attachment points, etc.

According to some embodiments, the method includes selecting a first object of the plurality of objects within the simulated scene at step 410. For example, the attachment system 310 illustrated in FIG. 3 may select a first object of the plurality of objects within the simulated scene. In one or more embodiments, the first object includes a plurality of attachment points comprising the first attachment point. The first object may be selected using any technique for selecting one item from a plurality of items. As such, the first object may be any object in the simulated AV environment scene, such as, for example, another vehicle, a pedestrian, a fence, etc.

According to some embodiments, the method includes selecting an attachment point of the object at step 415. For example, the attachment system 310 illustrated in FIG. 3 may select an attachment point of the object. As discussed above, any labeled object in a simulated AV environment scene may have any number of defined attachment points. The attachment point of the first object may be selected using any technique for selecting one item from a plurality of items.

According to some embodiments, the method includes making a decision, based on an assigned probability associated with a first attachment point of the first object, of whether to add a first attachment to the first object at a first attachment point at step 420. For example, the attachment system 310 illustrated in FIG. 3 may make a decision, based on the assigned probability associated with a first attachment point of the first object, of whether to add a first attachment to the first object at a first attachment point. As discussed above, each attachment point of each labeled object in the simulated AV environment scene may have an associated probability. The probability may be an empirically derived number representing the likelihood that a real-world instance of the labeled object would have an attachment attached at the attachment point. For example, a head attachment point of a pedestrian may be assigned a 50% probability, representing a 50% likelihood that the pedestrian would be wearing a hat or other head covering of some sort. As another example, a head attachment point of a rider of a motorcycle may be assigned a 95% probability, representing a 95% likelihood that a real-world motorcycle rider would be wearing a helmet. In one or more embodiments, the probability assigned to a given attachment point of a labeled object in a simulated AV environment scene dictates the percentage of the time that the attachment system 310 of FIG. 3 will decide to attach an attachment at the attachment point for a given instance of a modified simulated AV environment scene. Thus, over a large enough sample size (e.g., ten thousand modified simulated AV environment scenes), the percentage of modified simulated AV environment scenes having an attachment attached at a given attachment point will tend towards the probability assigned to the attachment point. In one or more embodiments, when the decision, based on the assigned probability for the attachment point, is that an attachment will not be added for this particular instance of a modified AV environment scene, the method ends. In one or more embodiments, when the decision, based on the assigned probability for the attachment point, is that an attachment will be added for this particular instance of a modified AV environment scene, the method proceeds to step 425.

According to some embodiments, the method includes selecting a first attachment from a plurality of attachments that are compatible with the attachment point at step 425. For example, the attachment system illustrated in FIG. 3 may select the first attachment from a plurality of attachments that are compatible with the attachment point. The selection of the attachment may be made using any technique for selecting one item from a group of such items. As an example, the selecting of the first attachment from the plurality of attachments may be a random selection. In one or more embodiments, the set of possible attachments from which the first attachment is selected is based on the type of labeled object having the attachment point, and the location of the attachment point on the object. For example, the head attachment point associated with a pedestrian object may have a set of possible attachments (e.g., baseball hat, top hat, sombrero, helmet, beret, etc.) that would not be appropriate as back attachments for a rider of a bicycle. Additionally or alternatively, the set of attachments for a given attachment point of a labeled object in a simulated AV environment scene may be based on a class of which the object is a member. For example, all multi-passenger capable motorized vehicles may belong to a common class, and a driver attachment point may have a set of possible attachments common to all vehicles in the class, regardless of the specificity with which the object is labeled.

According to some embodiments, the method includes adding, based on the decision, the first attachment to the first object to obtain a modified simulated scene comprising the first attachment attached to the first object at step 430. For example, the attachment system 310 illustrated in FIG. 3 may add, based on the decision, the first attachment to the first object to obtain a modified simulated scene comprising the first attachment attached to the first object. In one or more embodiments, when the first attachment is added to the first object, a bounding box associated with the first object may be modified to include the first attachment. For example, when the object is a bicycle, and the attachment is a rider, the bounding box for the bicycle may be enlarged to include the rider, but the label for the bounding box may remain bicycle.

Additionally or alternatively, an attachment may be assigned a bounding box separate from the object to which it is attached, and have a separate label. For example, when the object is a pedestrian, and the attachment is a bicycle being walked by the pedestrian, the attachment may be assigned a separate bounding box and labeled bicycle.

In one or more embodiments, adding the attachment may include adding other aspects related to the attachment and/or the object to which it is attached. Such other aspects may, for example, be part of a policy assigned to a given attachment, or part of an overall model that dictates when certain additional aspects should be added to a modified simulated AV environment scene when certain attachments are added to certain objects. As an example, adding a particular attachment to a certain object may be associated with data representing an animation related to the interaction between the object and the attachment (e.g., a bicycle being ridden versus being walked by a pedestrian). Such an animation may be included as part of the modified simulated AV environment scene. As another example, an attachment may be associated with an attachment policy that dictates how to alter various aspects of the attachment for the particular instantiation of the attachment in a particular modified simulated AV scene (e.g., the color or the attachment).

According to some embodiments, the method includes making a determination as to whether the attachment is associated with a second attachment point at step 435. For example, the attachment system 310 illustrated in FIG. 3 may determine whether the attachment is associated with a second attachment point. As discussed above, any attachment, like objects, may have any number of defined attachment points, which represent locations on the attachment at which other attachments may be added. For example, a rider attachment for a motorcycle object may have a head attachment point (e.g., where a helmet could be attached) and a back attachment point (e.g., where a backpack could be attached). In one or more embodiments, if the attachment does not have any attachment points, the method ends. In one or more embodiments, if the attachment does have an attachment point, the method proceeds to step 440.

According to some embodiments, the method includes making a second decision, based on a second assigned probability associated with the second attachment point, of whether to add a second attachment to the first attachment at the second attachment point at step 440. For example, the attachment system illustrated in FIG. 3 may make a second decision, based on a second assigned probability associated with the second attachment point, of whether to add a second attachment to the first attachment at the second attachment point. In one or more embodiments, like attachment points for objects, an attachment point of an attachment is associated with an assigned probability dictating whether the attachment system will make a decision to attach an attachment at the attachment point for a given instance of a modified simulated AV environment scene. In one or more embodiments, if the second decision, based on the probability assigned to the second attachment point, is to not add an attachment, the method ends. In one or more embodiments, if the second decision, based on the probability assigned to the second attachment point, is to add an attachment at the second attachment point, the method proceeds to step 445.

According to some embodiments, the method includes selecting the second attachment from a second plurality of attachments that are compatible with the second attachment point at step 445. For example, the attachment system 310 illustrated in FIG. 3 may select the second attachment from a second plurality of attachments that are compatible with the second attachment point.

According to some embodiments, the method includes adding, based on the second decision, the second attachment to the first attachment at step 450. For example, the attachment system 310 illustrated in FIG. 3 may add, based on the second decision, the second attachment to the first attachment.

According to some embodiments, the method includes providing the modified simulated scene as a set of inputs for training a ML model associated with AVs at step 455. For example, the simulated scene loader 305 illustrated in FIG. 3 may provide the modified simulated scene as a set of inputs for train a ML model associated with AVs. The modified simulated scene may include the first object with the first attachment attached, with the first attachment, in turn, having the second attachment attached. Thus, the simulated AV environment scene is modified to include the first attachment attached to the first object, and the second attachment added to the first attachment.

Although FIG. 4 describes adding one attachment to one object of a simulated AV environment scene, and one attachment to that attachment, one having ordinary skill in the art, and the benefit of this Detailed Description, will appreciate that, when generating a modified simulated AV environment scene, all attachment points of any labeled object in a simulated AV environment scene will be subjected to a determination, based on an assigned probability, of whether to add an attachment at the attachment point, as will all attachment points of any attachments that are added. Thus, for a given modified simulated AV environment scene, any object therein, and any attachment actually added to an object, may or may not have an attachment attached. Further, there may be any number of such modified simulated AV environment scenes generated to be used as inputs for training an ML model for an AV. As such, whether or not an attachment is added to a given attachment point may change from scene to scene. Further, the actual attachment that is added may change between modified simulated AV environment scenes, as the selection of which attachment to add may be random. Thus, each modified simulated AV environment scene generated as described above may differ from other modified simulated AV environment scenes, both in whether an attachment is or is not added at the attachment points, and, if added, what attachment is actually added. These differences, collectively, increase the diversity of the modified simulated scenes to be used as input for training AV ML models, which may improve the performance of the models when used by AVs. Additionally, as discussed above in the description of FIG. 3, the attachment system may add further attachments to attachments in a recursive manner having any number of layers of recursion without departing from the scope of embodiments described herein.

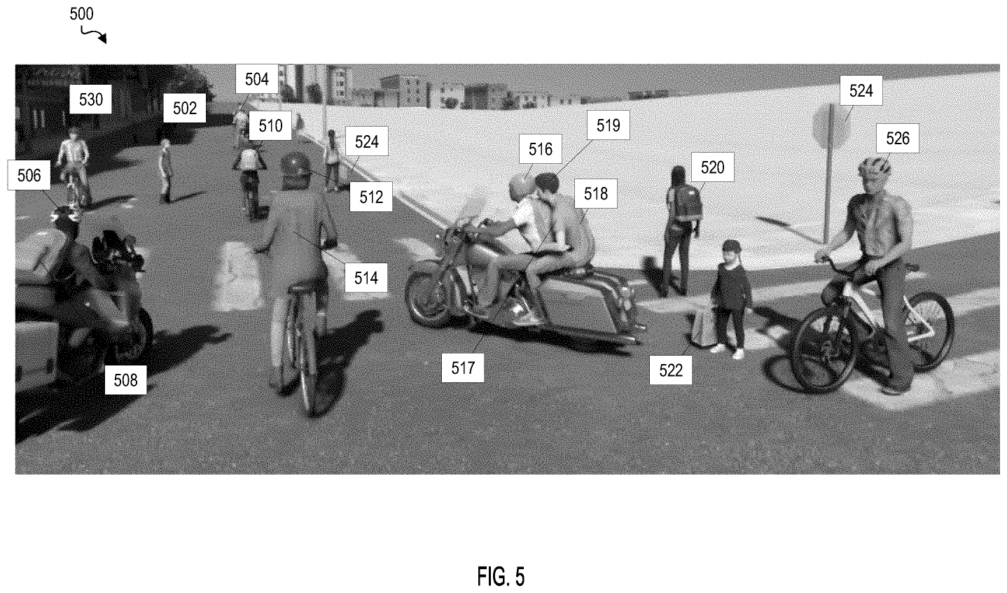

FIG. 5 shows an example of a modified simulated AV environment scene in accordance with one or more embodiments described herein. The following example is for explanatory purposes only and not intended to limit the scope of embodiments described herein. Additionally, while the example shows certain aspects of embodiments described herein, all possible aspects of such embodiments may not be illustrated in this particular example.

Referring to FIG. 5, consider a scenario where a simulation platform of a data center, in conjunction with an AI/ML platform of the datacenter, are to conduct training for an ML model that, when trained, will be deployed on AVs. In order to train the ML model, the simulation platform will obtain real-world data from AVs representing environments that the AVs have encountered. The simulation platform will convert the data into simulated AV environment scenes to be used as part of the training of the ML model. Although many such scenes, based on data from many AVs, may allow for training of the ML model, the training could be improved if the scenes were exponentially more diverse. However, waiting for, and actually collecting such a diverse set of data to convert to simulated AV environment scenes for ML model training may be expensive, in time, compute resources, and/or financially.

Therefore, in this scenario, the simulation platform includes an attachment system. The attachment system is capable of adding attachments to attachment points of labeled objects, or other attachments, in the simulated AV environment scene. By probabilistically adding attachments to objects and other attachments and varying what attachments are selected via a random selection of attachments from an attachment database, the attachment system exponentially increases the diversity of the scenes used to train the ML model.

One such modified simulated AV environment scene 500 is presented in FIG. 5. In modified simulated AV environment scene 500, there are a variety of objects, which are associated with bounding boxes (not shown) and corresponding labels (not shown). Modified simulated AV environment scene 500 also shows a variety of attachments added to objects, as well as objects for which no attachment was added for this particular instance of a modified simulated AV environment scene.

Element 502 of modified simulated AV environment scene 500 refers to a pedestrian. The pedestrian was a labeled object in the simulated AV environment scene received by the attachment system. Pedestrian objects have a head attachment point, a back attachment point, and two hand attachment points. Each attachment point has an associated probability that defines whether an attachment should be added to the attachment point for a particular instance of a modified simulated AV environment scene. Thus, the attachment system probabilistically selects whether or not to add an attachment at a given attachment point based on the probability for that attachment point. In the case of the pedestrian 502, for this particular instance of modified simulated ACV environment scene, the attachment system did not add an attachment to any of the attachment points for the pedestrian 502 for modified simulated AV environment scene 500.

Element 504 of modified simulated AV environment scene 500 refers to the helmet on the rider of the bicycle. The bicycle and rider were a labeled object in the simulated AV environment scene received by the attachment system. Based on the probability associated with the head attachment point of the rider, the attachment system made a decision to add an attachment, and randomly selected the helmet shown from a list of compatible head attachments for a bicycle rider from the attachment database for modified simulated AV environment scene 500.

Element 506 of modified simulated AV environment scene 500 refers to the helmet on the rider of the motorcycle. The motorcycle and rider were a labeled object in the simulated AV environment scene received by the attachment system. Based on the probability associated with the head attachment point of the rider, the attachment system made a decision to add an attachment and randomly selected the helmet shown from a list of compatible head attachments for a motorcycle rider from the attachment database for modified simulated AV environment scene 500.

Element 508 of modified simulated AV environment scene 500 refers to the backpack on the rider of the motorcycle. The motorcycle and rider were a labeled object in the simulated AV environment scene received by the attachment system. Based on the probability associated with the back attachment point of the rider, the attachment system made a decision to add an attachment, and randomly selected the backpack shown from a list of compatible back attachments for a motorcycle rider from the attachment database for modified simulated AV environment scene 500.

Element 510 of modified simulated AV environment scene 500 refers to the backpack on the rider of the bicycle. The bicycle and rider were a labeled object in the simulated AV environment scene received by the attachment system. Based on the probability associated with the back attachment point of the rider, the attachment system made a decision to add an attachment and randomly selected the backpack shown from a list of compatible back attachments for a bicycle rider from the attachment database for modified simulated AV environment scene 500.

Element 512 of modified simulated AV environment scene 500 refers to the helmet on the rider of the bicycle. The bicycle and rider were a labeled object in the simulated AV environment scene received by the attachment system. Based on the probability associated with the head attachment point of the rider, the attachment system made a decision to add an attachment and randomly selected the helmet shown from a list of compatible head attachments for a bicycle rider from the attachment database for modified simulated AV environment scene 500.

Element 514 of modified simulated AV environment scene 500 refers to the back attachment point on the rider of the bicycle. The bicycle and rider were a labeled object in the simulated AV environment scene received by the attachment system. Based on the probability associated with the back attachment point of the rider, the attachment system made a decision not to add a back attachment to the rider for modified simulated AV environment scene 500.

Element 516 of modified simulated AV environment scene 500 refers to the helmet on the rider of the motorcycle. The motorcycle and rider were a labeled object in the simulated AV environment scene received by the attachment system. Based on the probability associated with the head attachment point of the rider, the attachment system made a decision to add an attachment and randomly selected the helmet shown from a list of compatible head attachments for a motorcycle rider from the attachment database for modified simulated AV environment scene 500.

Element 517 of modified simulated AV environment scene 500 refers to the co-rider of the motorcycle. The motorcycle and rider were a labeled object in the simulated AV environment scene received by the attachment system. Based on the probability associated with the back attachment point of the rider, the attachment system made a decision to add an attachment, and randomly selected the co-rider shown from a list of compatible back attachments for a motorcycle rider from the attachment database for modified simulated AV environment scene 500.

Element 518 of modified simulated AV environment scene 500 refers to the back attachment point on the co-rider attachment attached to the rider of the motorcycle. The motorcycle and rider were a labeled object in the simulated AV environment scene received by the attachment system. As discussed above, the co-rider attachment was added to the scene by the attachment system. Based on the probability associated with the back attachment point of the co-rider attachment, the attachment system made a decision not to add a back attachment to the co-rider attachment for modified simulated AV environment scene 500.

Element 519 of modified simulated AV environment scene 500 refers to the head attachment point on the co-rider attachment attached to the rider of the motorcycle. The motorcycle and rider were a labeled object in the simulated AV environment scene received by the attachment system. As discussed above, the co-rider attachment was added to the scene by the attachment system. Based on the probability associated with the head attachment point of the co-rider attachment, the attachment system made a decision not to add a head attachment to the co-rider attachment for modified simulated AV environment scene 500.

Element 520 of modified simulated AV environment scene 500 refers to the backpack on the pedestrian. The pedestrian was a labeled object in the simulated AV environment scene received by the attachment system. Based on the probability associated with the back attachment point of the pedestrian object, the attachment system made a decision to add an attachment, and randomly selected the backpack shown from a list of compatible back attachments for a bicycle rider from the attachment database for modified simulated AV environment scene 500. Based on respective associated probabilities, the attachment system did not add a head attachment, left hand attachment, or right hand attachment to the pedestrian.

Element 522 of modified simulated AV environment scene 500 refers to the shopping bag in the right hand of the pedestrian. The pedestrian was a labeled object in the simulated AV environment scene received by the attachment system. Based on the probability associated with the right hand attachment point of the pedestrian object, the attachment system made a decision to add an attachment and randomly selected the shopping bag shown from a list of compatible hand attachments for a pedestrian from the attachment database for modified simulated AV environment scene 500. The attachment system did not add a head attachment, back attachment, or left hand attachment to the pedestrian based on respective associated probabilities.

Element 524 of modified simulated AV environment scene 500 refers to the sign. The sign was a labeled object in the simulated AV environment scene received by the attachment system. Based on the probability associated with the sign's attachment point, the attachment system made a decision not to add an attachment to the sign. Although not shown in FIG. 5, one of ordinary skill in the art will appreciate that the attachment system may add sign attachments to poles in simulated AV environment scenes.

Element 526 of modified simulated AV environment scene 500 refers to the helmet on the rider of the bicycle. The bicycle and rider were labeled objects in the simulated AV environment scene received by the attachment system. Based on the probability associated with the head attachment point of the rider, the attachment system made a decision to add an attachment, and randomly selected the helmet shown from a list of compatible head attachments for a bicycle rider from the attachment database for modified simulated AV environment scene 500.

Element 530 of modified simulated AV environment scene 500 refers to the helmet on the rider of the bicycle. The bicycle and rider were a labeled object in the simulated AV environment scene received by the attachment system. Based on the probability associated with the head attachment point of the rider, the attachment system made a decision to add an attachment, and randomly selected the helmet shown from a list of compatible head attachments for a bicycle rider from the attachment database for modified simulated AV environment scene 500.

Although FIG. 5 does not show a rider of a motorcycle or bicycle as an attachment, one of ordinary skill in the art will appreciate that such riders may, in fact, be attachments added by the attachment system.

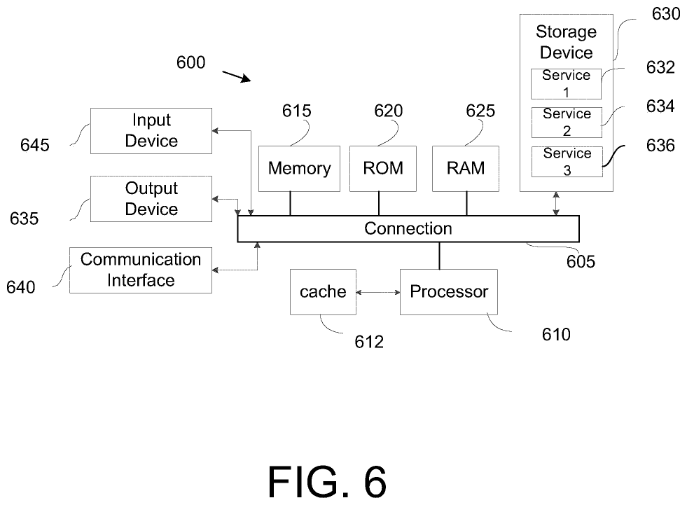

FIG. 6 shows an example of computing system 600, which can be, for example any computing device making up the simulation platform 156 of FIG. 1, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement, and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for increasing simulation diversity for autonomous vehicle (AV) machine learning (ML), the method comprising:
receiving a simulated AV environment scene, the simulated AV environment scene comprising a plurality of objects;
selecting a first object of the plurality of objects within the simulated AV environment scene;
making a decision, based on an assigned probability associated with a first attachment point of the first object, to add a first attachment to the first object at the first attachment point;
selecting the first attachment from a plurality of attachments that are compatible with the first attachment point;
adding, based on the decision, the first attachment to the first object to obtain a modified simulated AV environment scene comprising the first attachment attached to the first object; and
providing the modified simulated AV environment scene as a set of inputs for training a ML model associated with AVs.

2. The method of claim 1, further comprising, before providing the modified simulated AV environment scene:
determining that the first attachment is associated with a second attachment point;
making a second decision, based on a second assigned probability associated with the second attachment point, to add a second attachment to the first attachment at the second attachment point;
selecting the second attachment from a second plurality of attachments that are compatible with the second attachment point; and
adding, based on the second decision, the second attachment to the first attachment,
wherein the modified simulated AV environment scene further comprises the second attachment attached to the first attachment.

3. The method of claim 1, wherein the selecting of the first attachment from the plurality of attachments is a random selection.

4. The method of claim 1, further comprising, before providing the modified simulated AV environment scene, modifying a bounding box associated with the first object to include the first attachment.

5. The method of claim 1, wherein the first object is associated with a first bounding box, and the method further comprises adding a second bounding box associated with the first attachment to the modified simulated AV environment scene.

6. The method of claim 1, wherein the first object comprises a plurality of attachment points comprising the first attachment point.

7. The method of claim 6, wherein, when the first object is a vehicle, the plurality of attachment points comprises vehicle occupant attachment points.

8. The method of claim 6, wherein, when the first object is a pedestrian, the plurality of attachment points comprises a head attachment point, a back attachment point, and hand attachment points.

9. A non-transitory computer readable medium comprising instructions, the instructions, when executed by a computing system, cause the computing system to:
receive a simulated AV environment scene, the simulated AV environment scene comprising a plurality of objects;
select a first object of the plurality of objects within the simulated AV environment scene;
make a decision, based on an assigned probability associated with a first attachment point of the first object, to add a first attachment to the first object at the first attachment point;
select the first attachment from a plurality of attachments that are compatible with the first attachment point;
add, based on the decision, the first attachment to the first object to obtain a modified simulated AV environment scene comprising the first attachment attached to the first object; and
provide the modified simulated AV environment scene as a set of inputs for train a ML model associated with AVs.

10. The non-transitory computer readable medium of claim 9, wherein the simulated AV environment scene is based at least in part on real-world data received by a perception stack of an AV.

11. The non-transitory computer readable medium of claim 9, wherein the non-transitory computer readable medium further comprises instructions that, when executed by the computing system, cause the computing system to:
determine that the first attachment is associated with a second attachment point;
make a second decision, based on a second assigned probability associated with the second attachment point, to add a second attachment to the first attachment at the second attachment point;
select the second attachment from a second plurality of attachments that are compatible with the second attachment point; and
add, based on the second decision, the second attachment to the first attachment,
wherein the modified simulated AV environment scene further comprises the second attachment attached to the first attachment.

12. The non-transitory computer readable medium of claim 9, wherein the first object comprises a plurality of attachment points comprising the first attachment point.

13. The non-transitory computer readable medium of claim 12, wherein, when the first object is a vehicle, the plurality of attachment points comprises vehicle occupant attachment points.

14. The non-transitory computer readable medium of claim 12, wherein, when the first object is a pedestrian, the plurality of attachment points comprises a head attachment point, a back attachment point, and hand attachment points.

15. A system for increasing simulation diversity for autonomous vehicle (AV) machine learning, comprising:
a storage configured to store instructions; and
a processor configured to execute the instructions and cause the processor to:
receive a simulated AV environment scene, the simulated AV environment scene comprising a plurality of objects,
select a first object of the plurality of objects within the simulated AV environment scene,
make a decision, based on an assigned probability associated with a first attachment point of the first object, to add a first attachment to the first object at the first attachment point,
select the first attachment from a plurality of attachments that are compatible with the first attachment point,
add, based on the decision, the first attachment to the first object to obtain a modified simulated AV environment scene comprising the first attachment attached to the first object, and
provide the modified simulated AV environment scene as a set of inputs for train a ML model associated with AVs.

16. The system of claim 15, wherein the simulated AV environment scene is based at least in part on real-world data received by a perception stack of an AV.

17. The system of claim 15, wherein the processor is configured to execute the instructions and cause the processor to:
determine that the first attachment is associated with a second attachment point;
make a second decision, based on a second assigned probability associated with the second attachment point, to add a second attachment to the first attachment at the second attachment point;
select the second attachment from a second plurality of attachments that are compatible with the second attachment point; and
add, based on the second decision, the second attachment to the first attachment,
wherein the modified simulated AV environment scene further comprises the second attachment attached to the first attachment.

18. The system of claim 15, wherein before providing the modified simulated AV environment scene, the processor is configured to execute further instructions and cause the processor to modify a bounding box associated with the first object to include the first attachment.

19. The system of claim 15, wherein the first object is associated with a first bounding box, and the method further comprises adding a second bounding box associated with the first attachment to the modified simulated AV environment scene.

20. The system of claim 15, wherein the first object comprises a plurality of attachment points comprising the first attachment point.
